(19) United States
(12) Patent Application Publication
(10) Pub. No.: US 2025/0113028 A1
(43) Pub. Date: Apr. 3, 2025

(54) Method and Apparatus for Geometry Partition Mode MV Assignment in Video Coding System

(71) Applicant: MEDIATEK INC., Hsinchu City (TW)

(72) Inventors: Tzu-Der CHUANG, Hsinchu City (TW); Ching-Yeh CHEN, Hsinchu City (TW); Chih-Wei HSU, Hsinchu City (TW)

(21) Appl. No.: 18/730,932

(22) PCT Filed: Jan. 13, 2023
(86) PCT No.: PCT/CN2023/072055

§ 371 Date: Jul. 22, 2024

Related U.S. Application Data
(60) Provisional application No. 63/304,012, filed on Jan. 28, 2022.

(51) Int. Cl. H04N 19/119; H04N 19/105; H04N 19/139; H04N 19/176; H04N 19/70

(52) U.S. Cl. CPC H04N 19/119; H04N 19/105; H04N 19/139; H04N 19/176; H04N 19/70

(57) ABSTRACT

A method and apparatus for video coding are disclosed for the encoder side and the decoder side. According to the method for the decoder side, encoded data associated with a current block is received. A pseudo GPM in a target GPM group for the current block is determined. The current block is divided into one or more subblocks. Assigned MVs (Motion Vectors) of each subblock are determined according to the pseudo GPM. A cost for each GPM in the target GPM group is determined according to decoded data. A selected GPM is determined based on a mode syntax and a reordered target GPM group corresponding to the target GPM group reordered according to the costs, wherein the pseudo GPM is allowed to be different from the selected GPM. The encoded data is decoded using information comprising the selected GPM.

### CROSS REFERENCE TO RELATED APPLICATIONS

The present invention is a non-Provisional application of and claims priority to U.S. Provisional Patent Application No. 63/304,012 filed on Jan. 28, 2022. The U.S. Provisional patent application is hereby incorporated by reference in its entirety.

### FIELD OF THE INVENTION

The present invention relates to video coding. In particular, the present invention relates to a video coding system utilizing GPM (Geometric Partitioning Mode).

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, in-loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transformation 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

Merge Mode with MVD (MMVD)

In addition to the merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points for a L0 reference block and L1 reference block. An offset is added to either horizontal component or vertical component of the starting MV, where small circles in different styles correspond to different offsets from the centre. The relation of distance index and pre-defined offset is specified in Table 1.

TABLE 1
The relation of distance index and pre-defined offset

| | Distance IDX | | | | | | | |
|---|---|---|---|---|---|---|---|---|
| | 0 | 1 | 2 | 3 | 4 | 5 | 6 | 7 |
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent the four directions as shown in Table 2. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 2 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 2 specifies the sign of MV offset added to the list0 MV component of the starting MV and the sign for the list1 MV has an opposite value. Otherwise, if the difference of POC in list 1 is greater than list 0, the sign in Table 2 specifies the sign of the MV offset added to the list1 MV component of starting MV and the sign for the list0 MV has an opposite value.

The MVD is scaled according to the difference of POCs in each direction. If the differences of POCs in both lists are the same, no scaling is needed. Otherwise, if the difference of POC in list 0 is larger than the one in list 1, the MVD for list 1 is scaled, by defining the POC difference of L0 as td and POC difference of L1 as tb, described in FIG. 5. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks of current CU as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + w t * {P}_{i n t r a} + 2 ) >> 2 \qquad ( 1 )$$

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m,n ∈{3 . . . 6}excluding 8×64 and 64×8. The GPM mode can be applied to skip or merge CUs having a size within the above limit and having at least two regular merge modes.

When this mode is used, a CU is split into two parts by a geometrically located straight line in certain angles. In VVC, there are a total of 20 angles and 4 offset distances used for GPM, which has been reduced from 24 angles in an earlier draft. The 20 angles used for partition are shown in FIG. 2. The location of the splitting line is mathematically derived from the angle and offset parameters of a specific partition. In VVC, there are a total of 64 partitions as shown in FIG. 3, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 3, each line corresponds to the boundary of one partition. The partitions are grouped according to its angle. For example, partition group 310 consists of three vertical GPM partitions (i.e., 90°). Partition group 320 consists of four slant GPM partitions with a small angle from the vertical direction. Also, partition group 330 consists of three vertical GPM partitions (i.e., 270°) similar to those of group 310, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) as shown in Table 3 and specifies syntax binarization for GPM merge indices. The mapping among the GMP partition index, angle index and the distance index are shown in Table 4. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

TABLE 3
Syntax table for the number of maximum GPM candidate size

| | |
|---|---|
| if( MaxNumMergeCand >= 2 ) { | |
| sps_gpm_enabled_flag | u(1) |
| if( sps_gpm_enabled_flag && MaxNumMergeCand >= 3 ) | |
| sps_max_num_merge_cand_minus_max_num_gpm_cand | ue(v) |
| } | |

TABLE 4
Merge GPM Partition_Index Mapping Table

| merge_gpm_partition_idx | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 4. In case a corresponding LX motion vector of the n-the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 )$$

$${ρ}_{j} = {ρ}_{x , j} cos ( {φ}_{i} ) + {ρ}_{y , j} sin ( {φ}_{i} ) \qquad ( 3 )$$

$${ρ}_{x , j} = \{ \begin{matrix}0 & i \%16 = 8 or ( i \%16 \neq 0 and h \geq w ) \\ \pm ( j \times w ) >> 2 & otherwise\end{matrix} \qquad ( 4 )$$

$${ρ}_{y , j} = \{ \begin{matrix}\pm ( j \times h ) >> 2 & i \%16 = 8 or ( i \%16 \neq 0 and h \geq w ) \\ 0 & otherwise\end{matrix} \qquad ( 5 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdx L ( x , y ) = partIdx ? 32 + d ( x , y ) : 32 - d ( x , y ) \qquad ( 6 )$$

$${w}_{0} ( x , y ) = \frac{Clip 3 ( 0 , 8 , ( wIdxL ( x , y ) + 4 ) >> 3 )}{8} \qquad ( 7 )$$

$${w}_{1} ( x , y ) = 1 - {w}_{0} ( x , y ) \qquad ( 8 )$$

The partIdx depends on the angle index i. One example of weigh w₀ is illustrated in FIG. 5, where the angle φᵢ 510 and offset ρᵢ 520 are indicated for GPM index i and point 530 corresponds to the center of the block.

### Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

$$s T y p e = a b s ( motionIdx ) < 32 ? 2 : ( motionIdx \leq 0 ? ( 1 - partIdx ) : partIdx ) \qquad ( 9 )$$

where motionIdx is equal to d(4x+2, 4y+2), which is recalculated from equation (2). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### Template Matching Based Reordering for GPM Split Modes

Recently, a template matching based reordering for GPM split modes is disclosed in JVET-Y0135 (Chun-Chi Chen, et al., Non-EE2: Template matching based reordering for GPM split modes, ITU-T/ISO/IEC Joint Video Exploration Team (JVET), 25th Meeting, by teleconference, 12-21 Jan. 2022, document: document JVET-Y0135) for consideration of the emerging new coding standard. The template matching method matches the neighboring template around the current block with the reference template around a reference block(s) in a reference picture(s). The neighboring template usually comprises a top temple corresponding to neighboring pixels above the top edge of the current block and a left template corresponding to neighboring pixels to the left edge of the current block. The reference template comprises a respective top template and left template of the reference block(s). Since the reference template and the neighboring template are available at both the encoder side and the decoder side during the coding/decoding process for the current block, the matching costs (i.e., a measure of similarity or dis-similarity between the neighboring template and the reference template) can be evaluated at both the encoder side and the decoder side. Therefore, the matching cost evaluation is considered at a decoder-derived information. The reordering method for GPM split modes according to JVET-Y0135 is a two-step process after the respective reference templates of the two GPM partitions in a coding unit are generated, as follows:
blending the reference templates of the two GPM partitions using the respective weights of split modes (i.e., resulting in 64 blended reference templates) and computing the respective TM costs of these blended reference templates; and
reordering the TM costs in an ascending order and marking the best N candidates as available split modes.

The edge on the template is extended from that of the current CU, as shown in FIG. 6. In FIG. 6, block 610 corresponds to the current block, block 620 corresponds to the top template and block 630 corresponds to the left template. The corresponding weights used in the blending process of templates are computed similar to the GPM weight derivation process (i.e., subclause 8.5.7.2 in JVET-T2001 (Benjamin Bross, et al Versatile Video Coding Editorial Refinements on Draft 10, ITU-T/ISO/IEC Joint Video Exploration Team (JVET), 20th Meeting, by teleconference, 7-16 Oct. 2020, document: document JVET-T2001)). The only difference is as follows:
the sample positions (relative to the original of the CU) on the template are used to derive weights;
weights are mapped to 0 and 8 before use depending on whichever is closer and thus the edge on templates is clean cut for computational simplification in the blending process of templates.

After ascending reordering using the TM cost, the best N GPM split modes are assigned to their respective indices, according to their TM cost from small to large. Golomb-Rice code is used to signal this index as shown in Table 5.

TABLE 5
Golomb-Rice Code for the Best N GPM Split Modes

| | Binary code | |
|---|---|---|
| Index | Prefix | Suffix |
| 0-3 | 0 | 00-11 |
| 4-7 | 10 | 00-11 |
| 8-11 | 110 | 00-11 |
| . . . | . . . | . . . |
| 28-31 | 1111 111 | 00-11 |

The signaling of GPM index according to TM based reordering as disclosed in JVET-Y0135 is more efficient than the original signaling method without the TM based reordering since only best N GPM split modes are assigned to their respective indices and the selected index is entropy coded using Golomb-Rice code. However, the TM based reordering as disclosed in JVET-Y0135 suffers longer latency as disclosed in detailed description of this application. The present invention discloses methods to overcome the long latency issue.

### BRIEF SUMMARY OF THE INVENTION

A method and apparatus for video coding are disclosed for the encoder side and the decoder side. According to the method for the decoder side, encoded data associated with a current block is received. A pseudo GPM in a target GPM group for the current block is determined. The current block is divided into one or more subblocks. Assigned MVs (Motion Vectors) of each subblock are determined according to the pseudo GPM. A cost for each GPM in the target GPM group is determined according to decoded data. A selected GPM is determined based on a mode syntax and a reordered target GPM group corresponding to the target GPM group reordered according to the costs, wherein the pseudo GPM is allowed to be different from the selected GPM. The encoded data is decoded using information comprising the selected GPM.

In one embodiment, the method for the decoder side may further comprise parsing the mode syntax from a bitstream comprising the encoded data for the current block.

In one embodiment, the cost is derived between a reference template for a reference block of the current block and a neighboring template of the current block using one or more GPM mode selected MV candidates and a target-tested GPM.

In one embodiment, the target GPM group comprises all GPMs in a GPM list.

In one embodiment, all GPMs in a GPM list are divided into a plurality of GPM groups and the target GPM group corresponds to one of the plurality of GPM groups. In one embodiment, the plurality of GPM groups correspond to M groups, wherein M is an integer greater than 1. In one embodiment, a GPM group syntax is parsed from a bitstream comprising the encoded data for the current block, and wherein the GPM group syntax indicates the target GPM group among the plurality of GPM groups. In one embodiment, information related to said one of the plurality of GPM groups is parsed from a bitstream comprising the encoded data for the current block. In one embodiment, the mode syntax is parsed from a bitstream comprising the encoded data for the current block. In one embodiment, the mode syntax is determined implicitly.

According to the method for the encoder side, pixel data associated with a current block is received. A cost for each GPM in a target GPM group is determined according to decoded data. A reordered target GPM group for the GPMs in the target GPM group is generated according to the costs. A selected GPM is determining for current block. A mode syntax is determined depending on a location of the selected GPM in the reordered target GPM group. The current block is divided into one or more subblocks. A pseudo GPM in the target GPM group is determined for the current block according to the mode syntax. Assigned MVs (Motion Vectors) of each subblock are determined according to the pseudo GPM, wherein the pseudo GPM is allowed to be different from the selected GPM. The current block is then encoded using information comprising the selected GPM.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of the 20 angles used for geometric partitions during early GPM (Geometric Partition Mode) development in VVC.

FIG. 3 illustrates an example of the of 64 partitions used in the VVC standard, where the partitions are grouped according to their angles and dashed lines indicate redundant partitions.

FIG. 4 illustrates an example of uni-prediction MV selection for the geometric partitioning mode.

FIG. 5 illustrates an example of bending weight oo using the geometric partitioning mode.

FIG. 6 illustrates an example of extending the edge for a geometric partition mode into the template according to the template-matching based GPM.

FIG. 7 illustrates a flowchart of an exemplary video decoding system that utilizes low-latency geometric partition mode according to an embodiment of the present invention.

FIG. 8 illustrates a flowchart of an exemplary video encoding system that utilizes low-latency geometric partition mode according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

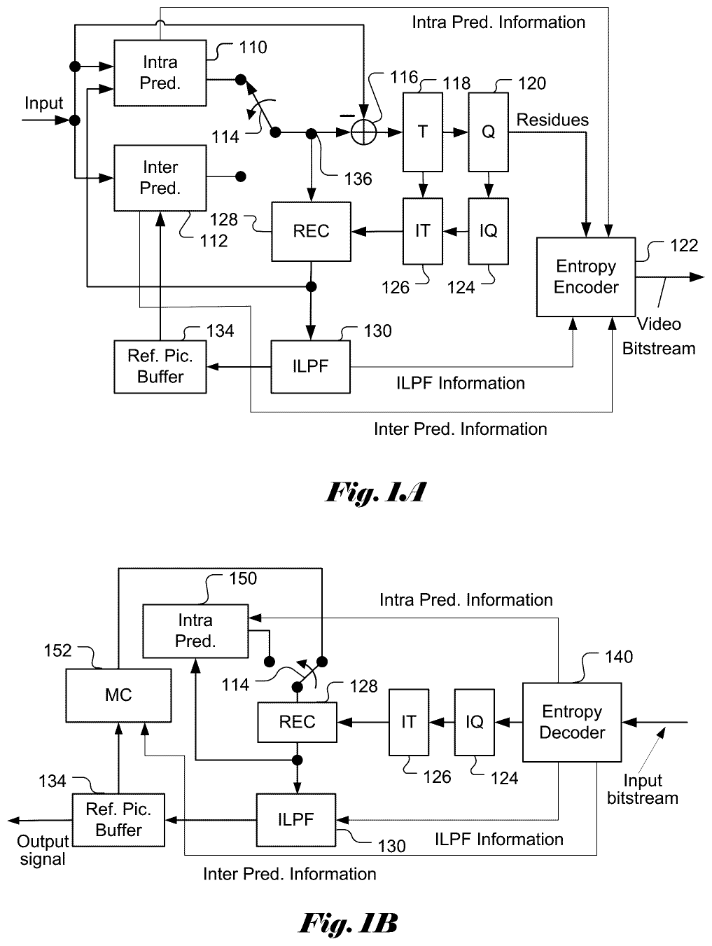

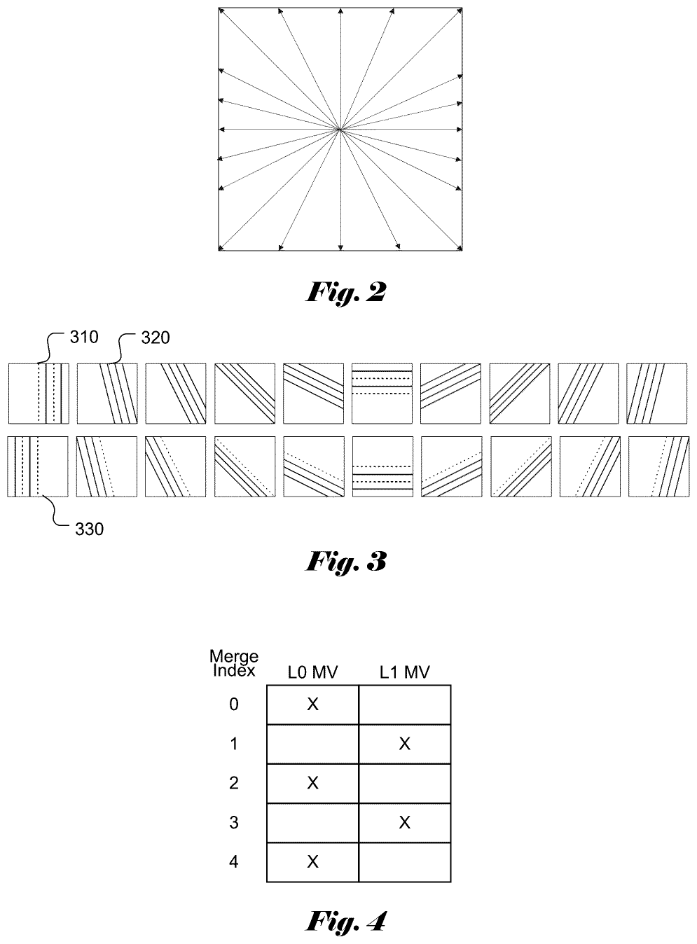

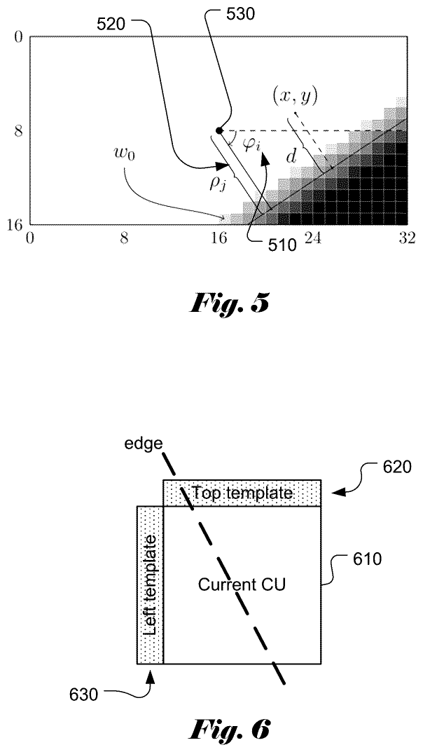

In GPM mode, how to the store the MV of each subblock is described in the background section. One of the MV1 and MV2 is selected to be stored in the subblock MV buffer according to the GPM partition mode (e.g. partition angle and offset). However, in the method disclosed in JVET-Y0135, the partition mode is reordered according to template matching costs. However, in a video decoder, in the parsing stage (e.g. the Entropy Decoder 140 in FIG. 1B), the reconstructed neighboring template is not available yet. Therefore, the reordered the GPM partition list cannot be derived in the parsing stage and the selected partition cannot be determined according to the parsed partition index. Accordingly, the MV for the subblocks cannot be assigned for the current block at the parsing stage. Thus, the subblock MV cannot be assigned and be referenced by the following CUs. Furthermore, the MVP candidate list (e.g. merge candidate list and AMVP candidate list) cannot be generated in the parsing stage. It causes a reference sample pre-fetch problem in the video decoder since the decoder usually generates the final MV of each CU in parsing stage and issues the data fetch instruction to fetch data from the external memory so that the pre-fetched data (e.g. reference samples in another picture) can be prepared on time in the sample reconstruction stage (e.g. the REC 128 in FIG. 1B). If the reference samples cannot be prepared before the reconstruction stage, it requires a long latency to fetch the reference samples from the external memory. The root cause is that the decoder cannot reconstruct the MV of a CU in the parsing stage.

According to the conventional TM-based GPM process as disclosed by JVET-Y0135, the MVs of the neighboring block (if the neighboring block is coded in the GPM mode) is unknown and the MV for the current block cannot be generated. Consequently, the reference samples cannot be loaded in the parsing stage. As is known in the field of video coding system, the reference pictures are usually stored in offline memory, such as DRAM (Dynamic Random Access Memory). The reference samples have to be loaded into internal memory for processing. The external memory access is typically slow and causes processing delay. The TM-based GPM has to wait for the reconstruction stage to complete so that the reconstructed neighboring template is available and the GPM reordering can be performed. After the GPM reordering is completed, the GPM selected for the current block can be determined based on the signaled GPM index and the reordered GPM list. After the selected GPM is determined for the current block, MVs for the subblocks of the current block can be assigned in the reconstruction stage.

Accordingly, the reference sample pre-fetch cannot be performed in the parsing stage, which causes long latency. In order to improve the decoding throughput, a new method is disclosed in this application.

As mentioned above, one reason causing long latency in the TM-based GPM is that the true MVs selected from a merge list for the current block cannot be generated in the parsing stage and have to wait till the reconstruction stage. In this invention, it is proposed to create or define a method of subblock MV assignment with the decoder-side MV/mode derivation tools with GPM (e.g. the template matching based reordering in JVET-Y-135) or any coding tools where the MV assignment depends on the process performed in sample reconstruction stage. When the syntax of GPM mode index indicating which reordered partition mode being selected is parsed, a predefined subblock MV assignment method for GPM mode can be determined without performing the decoder-side MV/mode derivation according to embodiments of the present invention. The predefined subblock MV is referred as a pseudo MV in this disclosure. For example, one of the partition mode in FIG. 3 can be assigned for one or more decoded GPM syntaxes. After the GPM syntax is decoded, a pseudo partition for subblock MV assignment is determined. Each subblock can select the corresponding MV (e.g. MV1 or MV2) according to the pseudo partition. The assigned MV can be used for the MV reconstruction for the neighboring blocks. In the sample reconstruction stage, the actual GPM partition is determined via decoder-side MV/mode derivation. Accordingly, in the reconstruction stage, the actual MV and the actual GPM are used. Furthermore, the sample blending is done with the correct GPM (actual GPM) partition mode derived by decoder-side MV/mode derivation and/or mode reordering. In the reconstruction stage, the real MVs are used to reconstruct the samples for the current blocks. On the other hand, the assigned MV according to the present invention is a pseudo MV for the pseudo GPM. In other words, the assigned MV may not be the same as the MV used for reconstruction using motion compensation. However, the stored subblock MV is determined with the pseudo partition mode. Furthermore, the pseudo GPM may not be the same as the actual GPM selected according to the reordered GPM list. In another embodiment, the pseudo partition can be a fixed partition that is independent of the parsed GPM syntax. For example, we always use top-right to bottom-left partition, top-left to bottom-right partition, horizontally split top-down partition, or vertically split left-right partition for the subblock MV assignment. In another embodiment, when decoder-side MV/mode derivation tools with GPM are applied, the fix partition or the pseudo GPM is applied. Otherwise (i.e., when decoder-side MV/mode derivation tools with GPM are not applied), the subblock MVs are assigned according to the selected GPM.

In another embodiment, for GPM partition signalling, some similar modes can be collected in a group. All the GPM partitions can be classified into several groups. For each group, one predefined subblock MV assignment is designed. The decoder-side MV/mode derivation can reorder the modes in the same group. The reordered modes in each group can be further re-assigned (e.g. take the one or more modes in each group in an interleaved manner) to the final reordered mode syntax. Therefore, when the GPM syntaxes are parsed, which group is selected can be known. The corresponding MV assignment is also determined. In one example, the GPM mode syntax/index is classified into different groups (e.g. mode indices can be classified into four groups as 4n, 4n+1, 4n+2, 4n+3. Or more general, classified into M groups as Mn, Mn+1, Mn+2, . . . Mn+(M−1).). For each group, one or more subblock MV assignment methods are predefined. Therefore, the subblock MV can be assigned in the parsing stage or said before the sample reconstruction stage. All the GPM modes within a group are reordered by decoder-side MV/mode derivation.

In another embodiment, the GPM partition mode is classified/quantize in to several grouped. Within each group, the exact GPM mode is derived by the decoder-side MV/mode derivation. Therefore, it only needs to signal which group is selected in the bitstream. The decoder can determine the exact GPM partition mode via the decoder-side MV/mode derivation. In each group, one or more subblock MV assignment method is predefined. Therefore, the subblock MV can be assigned in the parsing stage or said before the sample reconstruction stage.

Any of the foregoing proposed methods can be implemented in encoders and/or decoders. For example, any of the proposed methods can be implemented in an inter coding module of an encoder (e.g. Inter Pred. 112 in FIG. 1A), a motion compensation module, a merge/inter candidate derivation module of a decoder (e.g., MC 152 in FIG. 1B). Alternatively, any of the proposed methods can be implemented as a circuit coupled to the inter coding module of an encoder and/or motion compensation module, a merge/inter candidate derivation module of the decoder.

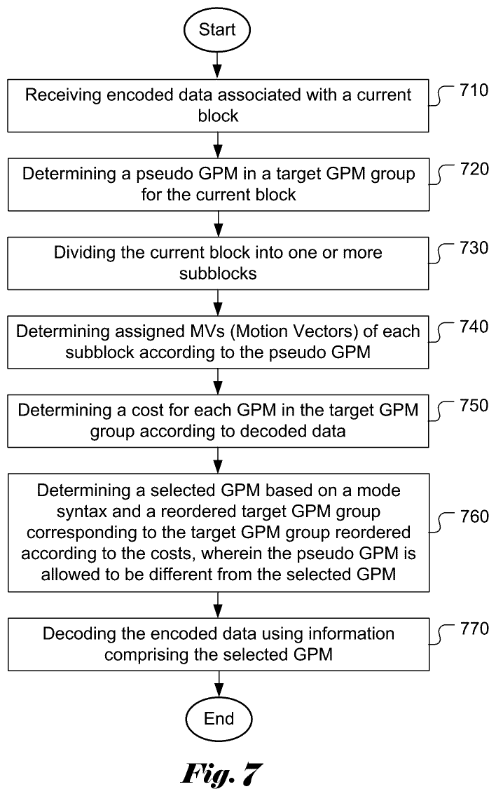

FIG. 7 illustrates a flowchart of an exemplary video decoding system that utilizes low-latency geometric partition mode according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, encoded data associated with a current block is received in step 710. A pseudo GPM in a target GPM group is determined for the current block in step 720. The current block is divided into one or more subblocks in step 730. Assigned MVs (Motion Vectors) of each subblock are determined according to the pseudo GPM in step 740. A cost for each GPM in the target GPM group is determined according to decoded data in step 750. A selected GPM is determined based on a mode syntax and a reordered target GPM group corresponding to the target GPM group reordered according to the costs in step 760, wherein the pseudo GPM is allowed to be different from the selected GPM. The encoded data is decoded using information comprising the selected GPM in step 770. In one embodiment, the cost in step 750 may be template matching(TM) cost and it can be derived between a reference template for a reference block of the current block using the assigned MVs and a neighboring template of the current block. In another embodiment, the cost in step 750 may be the boundary matching cost and it can be derived between a reference block of the current block and a neighboring template of the current block.

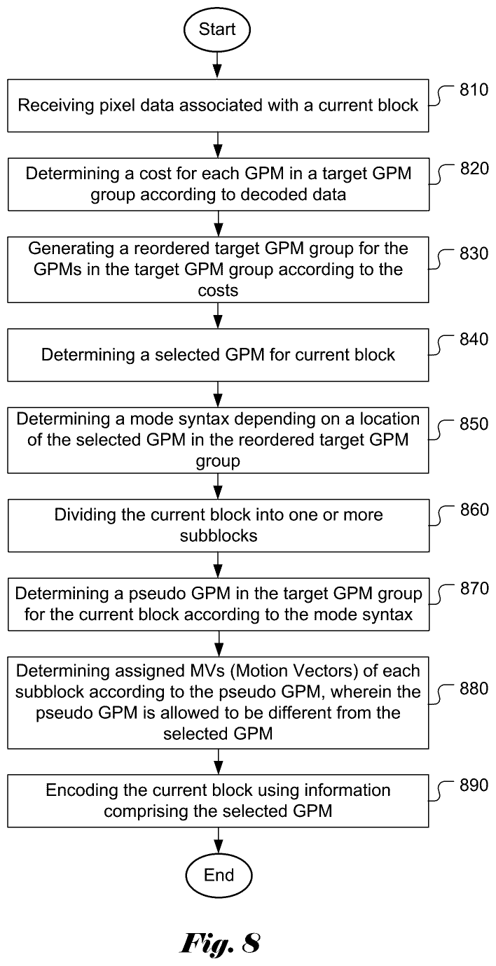

FIG. 8 illustrates a flowchart of an exemplary video encoding system that utilizes low-latency geometric partition mode according to an embodiment of the present invention. According to this method, pixel data associated with a current block is received in step 810. A cost for each GPM in a target GPM group is determined according to decoded data in step 820. A reordered target GPM group for the GPMs in the target GPM group is generated according to the costs in step 830. A selected GPM for current block is determined in step 840. A mode syntax is determined depending on a location of the selected GPM in the reordered target GPM group in step 850. The current block is divided into one or more subblocks in step 860. A pseudo GPM in the target GPM group for the current block is determined according to the mode syntax in step 870. Assigned MVs (Motion Vectors) of each subblock are determined according to the pseudo GPM in step 880, wherein the pseudo GPM is allowed to be different from the selected GPM. The current block is encoded using information comprising the selected GPM in step 890.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving encoded data associated with a current block;
determining a pseudo GPM in a target GPM group for the current block;
dividing the current block into one or more subblocks;
determining assigned MVs (Motion Vectors) of each subblock according to the pseudo GPM;
determining a cost for each GPM in the target GPM group according to decoded data;
determining a selected GPM based on a mode syntax and a reordered target GPM group corresponding to the target GPM group reordered according to the cost, wherein the pseudo GPM is allowed to be different from the selected GPM; and
decoding the encoded data using information comprising the selected GPM.

2. The method of claim 1 further comprises parsing the mode syntax from a bitstream comprising the encoded data for the current block.

3. The method of claim 1, wherein the cost is derived between a reference template for a reference block of the current block and a neighboring template of the current block using one or more GPM mode selected MV candidates and a target-tested GPM.

4. The method of claim 1, wherein the target GPM group comprises all GPMs in a GPM list.

5. The method of claim 1, wherein all GPMs in a GPM list are divided into a plurality of GPM groups and the target GPM group corresponds to one of the plurality of GPM groups.

6. The method of claim 5, wherein the plurality of GPM groups correspond to M groups, wherein M is an integer greater than 1.

7. The method of claim 5, wherein a GPM group syntax is parsed from a bitstream comprising the encoded data for the current block, and wherein the GPM group syntax indicates the target GPM group among the plurality of GPM groups.

8. The method of claim 5, wherein information related to said one of the plurality of GPM groups is parsed from a bitstream comprising the encoded data for the current block.

9. The method of claim 1, wherein the mode syntax is parsed from a bitstream comprising the encoded data for the current block.

10. The method of claim 5, wherein the mode syntax is determined implicitly.

11. A method of video encoding, the method comprising:
receiving pixel data associated with a current block;
determining a cost for each GPM in a target GPM group according to decoded data;
generating a reordered target GPM group for the GPMs in the target GPM group according to the cost;
determining a selected GPM for current block;
determining a mode syntax depending on a location of the selected GPM in the reordered target GPM group;
dividing the current block into one or more subblocks;
determining a pseudo GPM in the target GPM group for the current block according to the mode syntax;
determining assigned MVs (Motion Vectors) of each subblock according to the pseudo GPM, wherein the pseudo GPM is allowed to be different from the selected GPM; and
encoding the current block using information comprising the selected GPM.

12. The method of claim 11 further comprises signaling the mode syntax from a bitstream comprising encoded data for the current block.

13. An apparatus of video decoding, the apparatus comprising one or more electronics or processors arranged to:
receive encoded data associated with a current block;
determining a pseudo GPM in a target GPM group for the current block;
divide the current block into one or more subblocks;
determine assigned MVs (Motion Vectors) of each subblock according to the pseudo GPM;
determine a cost for each GPM in the target GPM group according to decoded data;
determine a selected GPM based on a mode syntax and a reordered target GPM group corresponding to the target GPM group reordered according to the cost, wherein the pseudo GPM is allowed to be different from the selected GPM; and
decode the encoded data using information comprising the selected GPM.

14. The apparatus of claim 13, wherein said one or more electronics or processors are further arranged to parse the mode syntax from a bitstream comprising the encoded data for the current block.
